(19) United States
(12) Patent Application Publication
(10) Pub. No.: US 2012/0228363 A1
(43) Pub. Date: Sep. 13, 2012

(54) PROCESS AND APPARATUS FOR PROVIDING A SOLAR CELL WITH A SOLDER RIBBON

(75) Inventors: Wolfgang Risch, Umkirch (DE); Joerg Zoennchen, Freiburg (DE); Karol Kamasinski, Freiburg (DE)

(73) Assignee: SOMONT GMBH, Umkirch (DE)

(21) Appl. No.: 13/421,800

(22) Filed: Mar. 15, 2012

Related U.S. Application Data
(63) Continuation-in-part of application No. PCT/IB2010/054146, filed on Sep. 14, 2010.

(30) Foreign Application Priority Data
Sep. 16, 2009 (EP) 09011796

(51) Int. Cl. B23K 31/02; B23K 31/12; B23K 1/20; B23K 3/00

(52) U.S. Cl. 228/103; 228/9

(57) ABSTRACT

Process and apparatus for providing a solar cell (2) with a solder ribbon (3), the cell (2) having at least one bus bar (7), wherein flux (4, 4a-4d) is applied by an automatically controlled spray head (5, 6), and the solder ribbon (3) is connected to a bus bar (7) by an automatically controlled soldering unit. Flux (4, 4a-4d) is only applied to locations of the ribbon (3) to be connected to the bus bar (7) and/or flux (4, 4a-4d) is only applied to those locations of the bars (7) to be connected to the ribbon (3). A solar cell (2), that has at least one bus bar (7), with a solder ribbon (3), may be provided by such apparatus and processes.

This application is a Continuation-In-Part (CIP) of copending PCT International application no. PCT/IB2010/054146 filed on Sep. 14, 2010 and published as WO2011/033451A2 on Mar. 24, 2011, which in turn claims benefit of priority to prior European application EP 09011796 filed on Sep. 16, 2009; the entirety of parent PCT International application no. PCT/IB2010/54146 is hereby expressly incorporated herein by reference, in its entirety and as to all its parts, for all intents and purposes, as if set forth identically in full herein.

The invention relates to a method and an apparatus for providing a solar cell, also called photovoltaic cell, with a solder ribbon.

In order to manufacture solar modules that may, for example, be placed on a roof of a building for solar energy generation, several solar cells with bus bars are typically connected in series with each other to form so-called strings. For this, bus bars of the solar cells are series-connected with the bus bars of neighboring solar cells by solder ribbons. A solder ribbon is thereby connected to the positive terminal of a solar cell and to the negative terminal of the neighbouring solar cell, i.e. the solder ribbon is alternatingly connected with the lower side of one solar cell and with the upper side of the neighboring solar cell. The solder ribbons are typically made of tinned copper and are connected with the bus bars by one or more soldering units. A solar cell can have several bus bars, in particular between one to three bus bars, which arrangement requires an equal amount of solder ribbons for forming a string. The strings are formed in an apparatus called stringer.

After the solar cell strings have been formed, they are typically transferred to a quality testing station for inspection of the alignment of the solar cells and the solder ribbons, as well as for the detection of possible breakage. Then the strings are placed next to each other and cross-linked to obtain a solar cell matrix. After the cross-linking, the solar cell matrix is laid sun-side down upon a glass plate with an adhesive layer and covered with a glass or plastics cover having an adhesive layer. Then the matrix is laminated in a laminator for protection purposes.

For facilitating the soldering when the solar cells are connected with the solder ribbons to form the strings, flux is typically employed as chemical cleaning agent to remove oxidation from the metals to be joined and to prevent the formation of metal oxides. Furthermore, the provision of flux allows the solder to flow easily rather than to form beads. The flux is usually provided by the solder ribbon or the solar cell running through a flux bath or by applying the flux to the solder ribbon with a brush or a spray head with the entire solder ribbon being brushed. The known methods have the disadvantage that the flux does not only come to lie on the bus bars but often also on the semiconductor material of the solar cells, which might cause damage to solar cells and might impair the laminating process of the solar modules formed from the solar cells. In such a case, the flux might evaporate over time, even when inside a solar panel.

The invention relates to the context of providing a process and an apparatus for providing a solar cell with a solder ribbon, by which these above disadvantages and/or others may be avoided. In aspects, the invention also relates to the context of providing a method and an apparatus for providing a solar cell with a solder ribbon, by which the fluxing and soldering process may be expedited. In further aspects, the invention also relates to the context of providing a process and an apparatus for providing a solar cell with a solder ribbon, by which the amount of required flux may possibly be reduced.

In order to seek these or still further advantages by implementations of the invention, as shall become more readily apparent as the description proceeds, a process for providing a solar cell that has at least one bus bar with a solder ribbon is provided, wherein flux is applied by at least one automatically controlled spray head, and the solder ribbon is connected to the bus bar by at least one automatically controlled soldering unit. The flux may be applied only to those locations of the solder ribbon that shall be connected to the bus bar by the one or more soldering units. Alternatively or additionally, the flux may be applied only to those locations of the bus bar that shall be connected to the solder ribbon by the one or more soldering units, i.e., the locations of the applied flux correspond to/correlate with the locations at which the solder ribbon is soldered after application of the flux.

A version of the apparatus may include at least one automatically controlled spray head for applying flux and at least one automatically controlled soldering unit for connecting a solder ribbon to a bus bar. The spray head may be controlled such that the flux is applied only to those locations of the solder ribbon that shall be connected to the bus bar, by the one or more soldering units when the apparatus is operated. Alternatively or additionally, the spray head may be controlled such that the flux is applied only to those locations of the bus bar that shall be connected to the solder ribbon by the one or more soldering units when the apparatus is operated. A control unit may be provided for controlling the at least one spray head. It may form part of the spray head.

In versions thereof, the process and the apparatus have the advantages that less flux is required and that the fluxing and soldering process may be performed faster than with the above-mentioned known methods and corresponding apparatuses. The process and the apparatus may of course also be applied if the solar cells have several bus bars, wherein each bus bar shall preferably be connected with a solder ribbon.

Preferably, a preheating unit may be provided for preheating the solder ribbon and/or the bus bar, so as to reduce the amount of alcohol in the flux and/or to activate the flux. For the preheating, the preheating unit may employ any kind of heating mechanism/technology such as a laser, a heat die, a soldering iron and/or the provision of heated air. The preheating unit and hence the temperature it provides are preferably controllable. If the solder ribbon and the bus bar shall be connected by wet soldering, the preheating unit is preferably controlled such that the temperature it generates is less than 80 degrees Celsius so that relatively little solvent, e.g. alcohol, is evaporated from the flux. If the solder ribbon and the bus bar shall be connected by dry soldering, the preheating unit is preferably controlled such that the temperature it generates is equal to or higher than 80 degrees Celsius so that a relatively large amount of alcohol is evaporated from the flux and the amount of solvent is thereby reduced. By setting the temperature that the preheating unit generates equal to or higher than 100 degrees Celsius, the flux may be activated, whereas if the temperature the preheating unit generates remains lower than 100 degrees Celsius, activation of the flux typically does not occur. The preheating unit may comprise a soldering tip, a laser, a unit for generating ultrasound and/or a unit for generating hot air, among others. The actual connecting of the solder ribbon to the bus bar by soldering takes place by a temperature of approximately 100 to 120 degrees Celsius. During the soldering, preferably just the areas of the solder ribbon and/or the bus bar may be heated, onto which flux has been previously applied. Alternatively, an elongated area of the solder ribbon and/or the bus bar may be heated, that includes the areas onto which flux has been applied, wherein the direction of elongation corresponds to the longitudinal extension of the solder ribbon and/or the bus bar. In this latter case, soldering mainly takes place at the locations onto which flux has been applied.

Preferentially a monitoring unit is provided that preferably comprises a camera, preferably a camera that can take range images, i.e. 3D-images. A 2D-camera or a line sensor may also be used. The monitoring unit monitors the position of the bus bars so that the position of the one or more spray heads may be controlled and corrected by the control unit in dependence on the monitored positions of the bus bars to ensure that the flux is applied to those locations on the bus bars that shall be connected to solder ribbon, i.e. to the “correct” locations. The monitoring by the monitoring unit may be done before the flux is actually applied for process control and/or after the flux is actually applied for quality inspection.

The monitoring unit furthermore preferably detects and monitors the actual locations on the solder ribbon and/or the bus bar on which the flux is or has been, respectively, applied by the one or more spray heads. These monitored actual locations of the flux are then compared by the monitoring unit or a control unit with those predetermined locations of the solder ribbon and/or the bus bar that shall be connected to the bus bar and/or the solder ribbon by the one or more soldering units. If there is a difference between the monitored actual locations to which flux has been applied and the predetermined locations that shall be connected by soldering, then the position of the one or more spray heads is controlled by a control unit such that this difference converges to zero or is at least minimized.

If the one or more spray heads are wider than a bus bar and/or a solder ribbon, onto which flux shall be applied, and comprise a set of spray nozzles that are arranged in an array, then the control unit is preferably configured so that it can control the one or more spray heads to disperse flux from a subset of spray nozzles arranged in an area that is not wider than the bus bar and/or the solder ribbon.

Further advantageous features and applications of versions of the invention shall become evident from the remaining disclosure, the following description of the drawings illustrating the invention, and the drawings. In the drawings like reference signs designate the same or similar parts throughout the several figures, in which:

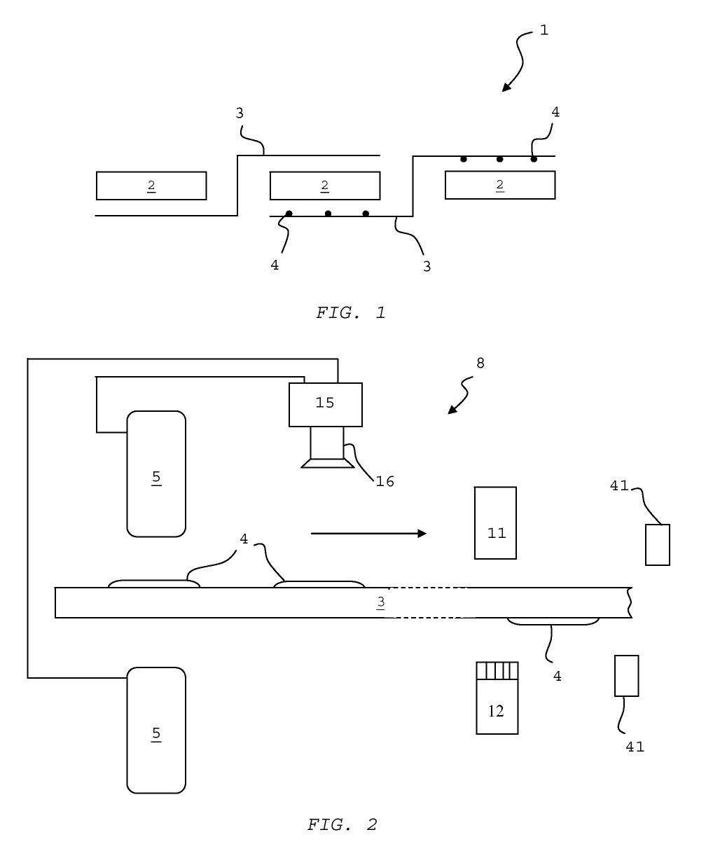

FIG. 1 schematically shows a side view of a string;

FIG. 2 schematically shows a partial side view of a first version of an apparatus according to the invention;

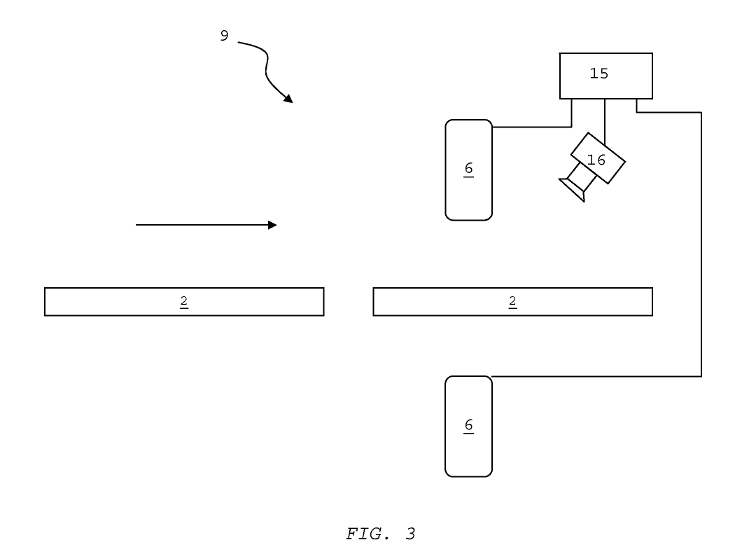

FIG. 3 schematically shows a partial side view of a second version of an apparatus according to the invention;

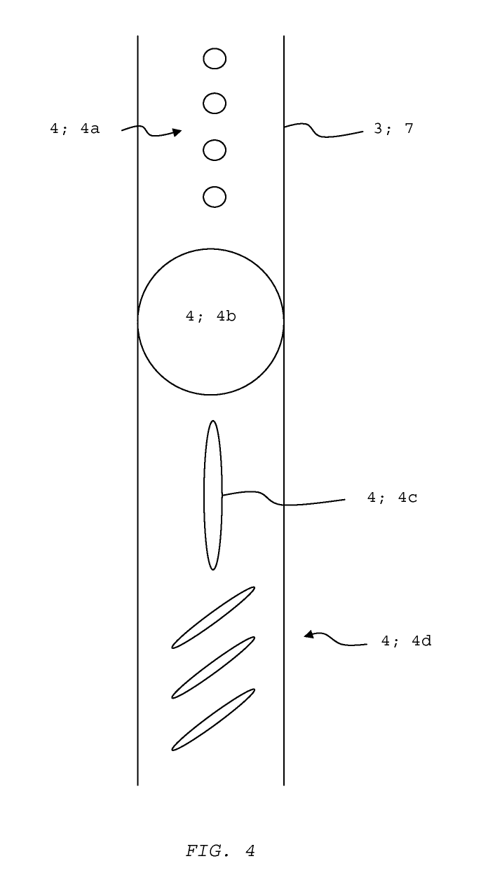

FIG. 4 depicts a schematic top view onto a solder ribbon or a bus bar with flux applied; and,

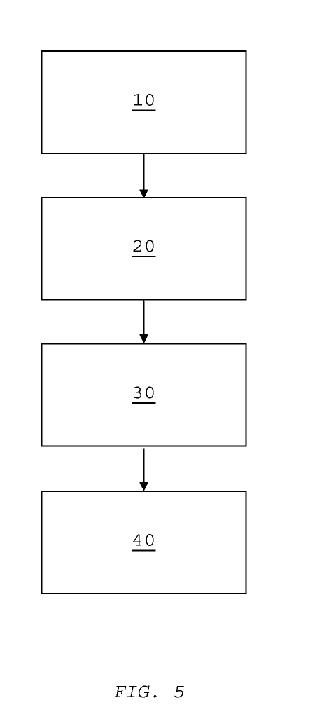

FIG. 5 shows a flow chart of a process according to the invention.

FIG. 1 schematically depicts an exemplary version of a string 1 including three solar cells 2 that are connected to each other in series by solder ribbons 3 (for ease of presentation the solar cells 2 and the solder ribbons 3 are depicted in exploded view). The solder ribbons 3 connect a positive terminal of one solar cell 2 to a negative terminal of a neighboring solar cell 2, i.e., the solder ribbons 3 are alternatingly connected to an upper surface and a lower surface of neighbouring solar cells 2. The upper surface is defined as that surface that faces the sun when the solar cells 2 are put into service. The lower surface is the surface opposite to the upper surface. The length of a solder ribbon 3 is approximately twice the length of a solar cell 2. Where the solder ribbon 3 respectively faces either the upper surface or the lower surface of a respective solar cell 2, it is provided with flux 4 at specific locations respectively on the upper side and the lower side of the solder ribbon 3, and only at these specific locations. These specific locations correspond to those predetermined locations that shall later be connected to a bus bar (not represented in FIG. 1, see FIG. 4) by one or more soldering units 41, FIG. 2. Alternatively or additionally, the flux may be applied to specific locations on the one or more bus bars 7.

FIG. 2 schematically shows part of a first version 8 of an apparatus, in side view, with spray heads 5 and a solder ribbon 3 running in between them. Flux 4 is applied onto the upper and lower sides of the solder ribbon 3 only at those locations where the solder ribbon 3 is going to be connected with a bus bar of a solar cell by soldering. For the spraying of the flux, there are a spray head 5 positioned above and another spray head 5 positioned below the solder ribbon 3, the spray nozzles of the spray heads 5 pointing towards the solder ribbon 3. Of course, there may be provided several spray heads 5 above and below the solder ribbon 3. The arrow indicates the direction of movement of the solder ribbon 3, with the position of the spray heads 5 fixed. The solder ribbon 3 is typically held, stretched and incrementally, as for example under clock cycles, moved by grabbers (not depicted).

FIG. 3 schematically depicts part of a second version 9 of an apparatus with spray heads 6 and solar cells 2 running in between them. As in FIG. 2, one spray head 6 is positioned above the solar cells 2 and one spray head 6 is positioned below the solar cells 2. Of course, there may be provided several spray heads 6 above and below the solar cells 2, while the position of the spray heads remains fixed. The spray heads 6 spray flux (FIG. 6) onto the bus bars 7 (FIG. 4) of the solar cells 2. The arrow indicates the direction of movement of the solar cells 2. The solar cells 2 are typically held and incrementally moved by holders with suction cups (not depicted) or by two parallel running conveyor belts (not depicted) with each conveyor belt supporting a border area of a solar cell 2, these border areas having no bus bars.

In the versions 8, 9 shown in FIGS. 2 and 3 the spray heads 5, 6 are controlled such by a control unit 15 so that flux 4 is applied only to those respective locations on the solder ribbon 3 or the bus bar 7, respectively, of the solar cells 2 which are then connected to bus bar 7 or the solder ribbon 3, respectively, by soldering. Of course, it is also possible to combine the versions 8, 9 shown in FIGS. 2 and 3 so that flux 4 is applied to the solder ribbon 3 and the bus bar but only at those locations where the bus bar and the solder ribbon 3 shall be connected.

FIG. 4 shows a top view of a solder ribbon 3 or a bus bar 7 of a solar cell, respectively, onto which flux has been sprayed by one or more spray heads 5, 6. The spray heads 5, 6 disperse the flux usually in the form of flux drops. By the control unit 15 the one or more spray heads 5, 6 are preferably controlled such that the size of the flux drops may be controlled, as well as the pattern in which the flux drops are dispersed onto the solder ribbon 3/bus bar 7. Furthermore, the control unit 15 may be configured so that it may control the speed of the flux drops dispersed by the one or more spray heads 5, 6, i.e., the speed with which the flux drops hit a solder ribbon 3 or a bus bar 7. The diameter of the flux drops that such can be obtained may, for example, vary between some micrometres and several millimetres. Different patterns may be obtained by controlling the position of the one or more spray head 5, 6 and by moving under control of the control unit 15 the one or more spray heads 5, 6 in a plane that lies in parallel to a surface of the solder ribbon 3 or the solar cell 2. For example, the position of a spray head 5, 6 can be controlled such that the flux is only dispersed in the middle or along a centre line of a solder ribbon 3/bus bar 7 so that contact of the flux with the actual semiconductor material of the solar cell may be advantageously avoided, as the flux might possibly damage the semiconductor material and thereby impede the functioning of the solar cell.

FIG. 4 schematically depicts various examples of applied flux. As schematically depicted, at the top of the solder ribbon 3/bus bar 7 depicted in FIG. 4, the flux 4 has been applied as relatively small flux drops 4a on a centre line of the solder ribbon 3/bus bar 7. Below the flux drops 4a a relatively large flux drop 4b has been dispersed whose diameter is approximately equal to the width of the solder ribbon 3/bus bar 7 but who does not go beyond the solder ribbon 3/bus bar 7 so that contact with the semiconductor material of the solar cell is avoided. Below the relatively large flux drop 4b a line 4c of flux has been dispersed on the centre line of the solder ribbon 3/bus bar 7. In this context, the terminology “line of flux” is to be generally understood to mean a pattern with elongated linear segmental aspect. At the bottom of FIG. 4, the flux has been dispersed in a pattern of several inclined lines 4d. The flux drop sizes and patterns shown in FIG. 4 are only exemplary. Several other possible flux drop sizes and patterns may be understood therefrom.

FIG. 5 depicts a flow chart of a process according to the invention. In a first step 10 either a solder ribbon or a bus bar, depending on where the flux shall be applied, is preheated by a preheating unit 11 (FIG. 2) to a first predefined temperature for removing alcohol from the flux. If the first temperature is set below 80 degrees Celsius, then enough alcohol remains in the flux that the solder ribbon and the bus bar may be connected by wet soldering. If the first temperature is set equal to or above 80 degrees Celsius, then enough alcohol is removed from the flux that the solder ribbon and the bus bar may be connected by dry soldering. The preheating preferably occurs only at those locations of the solder ribbon and/or the bus bar that shall be connected, subsequently, by this soldering. The preheating unit may comprise several preheating subunits 12, each subunit 12 being assigned to one of these locations.

In a second step 20 the temperature provided by the preheating unit 11 may be set to a second predefined temperature that preferably is equal to or higher then 100 degrees Celsius if activating of the flux is desired before the actual soldering starts. Alternatively, the second predefined temperature may be given by the first predefined temperature, if the first predefined temperature is smaller than 100 degrees Celsius; or, it may be set to a temperature below 100 degrees Celsius if activation of the flux shall first occur with the soldering. In step 20 the preheating preferably also occurs only at those locations of the solder ribbon and/or the bus bar that shall be subsequently connected by soldering.

In a third step 30 the flux is applied by the one or more spray heads 5,6 to the solder ribbon and/or the bus bar with specific flux drop sizes and/or in specific patterns, as described previously with regard to exemplary showings in FIG. 4, but only at those locations of the solder ribbon and/or the bus bar that shall be subsequently connected by soldering.

In a fourth step 40, the solder ribbon and the bus bar are then soldered together by one or more soldering units 41 at the predetermined locations.

The steps 10 and 20 are optional, wherein either both steps 10 and 20, only step 10 or only step 20 or neither step 10 nor step 20 may be performed. Furthermore, it is preferably monitored by a monitoring unit 16 if those locations onto which flux is applied actually correspond to those predetermined locations that shall be soldered. If such is not the case, the position of the one or more spray heads 5,6 is corrected as described previously.

In closing, it should be noted that the invention is not limited to the abovementioned versions and exemplary working examples. Further developments, modifications and combinations are also within the scope of the patent claims and are placed in the possession of the person skilled in the art from the above disclosure. Accordingly, the techniques and structures described and illustrated herein should be understood to be illustrative and exemplary, and not limiting upon the scope of the present invention. The scope of the present invention is defined by the appended claims, including known equivalents and unforeseeable equivalents at the time of filing of this application.

What is claimed is:

1. A process for providing a solar cell with a solder ribbon comprising the steps of:
applying flux to a solder ribbon with at least one automatically controlled spray head;
applying the flux only to those locations of the solder ribbon that are to be connected to a bus bar; and,
monitoring with a monitoring unit the actual locations to which the flux is actually applied on the solder ribbon.

2. A process for providing a solar cell with a solder ribbon as claimed in claim 1 further comprising the step of:
selectively controlling the spray head with a control unit to selectively control at least one of the process parameters selected from the group of process parameters consisting of flux drop size, flux application pattern, and flux application speed.

3. A process for providing a solar cell with a solder ribbon as claimed in claim 1 further comprising the step of:
preheating the solder ribbon.

4. The process for providing a solar cell with a solder ribbon as claimed in claim 3 wherein:
said step of preheating the solder ribbon occurs before the step of applying the flux.

5. The process for providing a solar cell with a solder ribbon as claimed in claim 3 wherein:
said step of preheating the solder ribbon occurs before,
a step of soldering the solder ribbon.

6. A process for providing a solar cell with a solder ribbon as claimed in claim 3 further comprising the step of:
selecting a preheating temperature less than 80 degrees Celsius if the solder ribbon is connected to the bus bar by wet soldering.

7. A process for providing a solar cell with a solder ribbon as claimed in claim 3 further comprising the step of:
selecting a preheating temperature of at least 80 degrees Celsius to reduce an amount of solvent.

8. A process for providing a solar cell with a solder ribbon as claimed in claim 1 further comprising the step of:
exposing the flux to a temperature of at least 100 degrees Celsius to activate the flux.

9. A process for providing a solar cell with a solder ribbon as claimed in claim 1 further comprising the steps of:
comparing the monitored actual locations to which the flux is actually applied on the solder ribbon, to locations that are to be connected by at least one soldering unit; and,
controlling the position of the at least one spray head to minimize the difference between the monitored actual locations to which the flux is actually applied on the solder ribbon, and the locations that are to be connected by the at least one soldering unit.

10. A process for providing a solar cell with a solder ribbon comprising the steps of:
applying flux to a bus bar with at least one automatically controlled spray head;
applying the flux only to those locations of the bus bar that are to be connected to a solder ribbon; and,
monitoring with a monitoring unit the actual locations to which the flux is actually applied on the bus bar.

11. A process for providing a solar cell with a solder ribbon as claimed in claim 10 further comprising the step of:
selectively controlling the spray head with a control unit to selectively control at least one of the process parameters selected from the group of process parameters consisting of flux drop size, flux application pattern, and flux application speed.

12. A process for providing a solar cell with a solder ribbon as claimed in claim 10 further comprising the step of:
preheating the bus bar.

13. The process for providing a solar cell with a solder ribbon as claimed in claim 12 wherein:
said step of preheating the bus bar occurs before the step of applying the flux.

14. The process for providing a solar cell with a solder ribbon as claimed in claim 12 wherein:
said step of preheating the bus bar occurs before,
a step of soldering the bus bar.

15. A process for providing a solar cell with a solder ribbon as claimed in claim 12 further comprising the step of:
selecting a preheating temperature less than 80 degrees Celsius if the bus bar is connected to the solder ribbon by wet soldering.

16. A process for providing a solar cell with a solder ribbon as claimed in claim 12 further comprising the step of:
selecting a preheating temperature of at least 80 degrees Celsius to reduce an amount of solvent.

17. A process for providing a solar cell with a solder ribbon as claimed in claim 10 further comprising the step of:
exposing the flux to a temperature of at least 100 degrees Celsius to activate the flux.

18. A process for providing a solar cell with a solder ribbon as claimed in claim 10 further comprising the steps of:
comparing the monitored actual locations to which the flux is actually applied on the bus bar, to locations that are to be connected by at least one soldering unit; and,
controlling the position of the at least one spray head to minimize the difference between the monitored actual locations to which the flux is actually applied on the bus bar, and the locations that are to be connected by the at least one soldering unit.

19. Apparatus for processing a solar cell comprising:
an automatically controlled soldering unit configured to join solder ribbons to bus bars;
an automatically controlled spray head configured to apply flux to solder ribbon;
a control unit configured to control said spray head to apply flux only to those locations of a solder ribbon that are to connect to a bus bar, said control unit being in operative communication with said spray head; and,
a camera configured to monitor actual locations on solder ribbon to which said spray head applies flux, said monitoring unit being in operative communication with said control unit.

20. An apparatus for processing a solar cell as claimed in claim 19 further comprising:
a controllable preheating unit configured to controllably preheat solder ribbon.

21. Apparatus for processing a solar cell comprising:
an automatically controlled soldering unit configured to join solder ribbons to bus bars;
an automatically controlled spray head configured to apply flux to bus bars;
a control unit configured to control said spray head to apply flux only to those locations of a bus bar that are to connect to a solder ribbon, said control unit being in operative communication with said spray head; and,
a camera configured to monitor actual locations on bus bar to which said spray head applies flux, said monitoring unit being in operative communication with said control unit.

22. An apparatus for processing a solar cell as claimed in claim 21 further comprising:
a controllable preheating unit configured to controllably preheat bus bar.
